(19) United States
(12) Patent Application Publication
(10) Pub. No.: US 2026/0296970 A1
(43) Pub. Date: Oct. 1, 2026

(54) OPTIMIZATION OF COLOR IN THE MECHANOCHEMICAL ACTIVATION OF CLAYS

(71) Applicants: thyssenkrupp Polysius GmbH, Beckum (DE); thyssenkrupp AG, Essen (DE); Schwenk Zement GmbH & Co. KG, Ulm (DE); Celitement GmbH & Co. KG, Eggenstein-Leopoldshafen (DE)

(72) Inventors: Michael Wilczek, Warendorf (DE); Oliver Maier, Münster (DE); Karl Lampe, Ennigerloh (DE); Carsten Sachse, Münster (DE); Jan Strotmann, Coesfeld (DE); Eike Willms, Dortmund (DE); Luc Rudowski, Aix en Provence (FR); Hendrik Möller, Allmendingen (DE); Andreas Hamm, Elchingen (DE); Daniel Hinder, Eggenstein-Leopoldshafen (DE); Marc Fylak, Wendelstein (DE); Thomas Neumann, Karlstadt (DE)

(21) Appl. No.: 19/164,426

(22) PCT Filed: Mar. 11, 2024
(86) PCT No.: PCT/EP2024/056410

§ 371 Date: Sep. 11, 2025

(30) Foreign Application Priority Data
Mar. 13, 2023 (DE) 10 2023 106 222.0
Mar. 13, 2023 (LU) LU503623

(51) Int. Cl. C04B 20/02; C04B 103/54

(52) U.S. Cl. CPC C04B 20/026; C04B 20/023; C04B 2103/54

(57) ABSTRACT

A method for the mechanochemical activation and simultaneous color optimization of mineral material, characterized in that the mechanochemical activation and simultaneous color optimization take place in a first high-energy mill (40), the mineral material being ground together with a solid reducing agent in the first high-energy mill (40).

The invention relates to a method for the optimization of color in the mechanochemical activation of clays.

Activated clays have become established as additives, particularly in the cement industry. At present, the usual method is drying and calcination of the clays, i.e. a thermal activation. This requires energy for the heating on the one hand, and on the other hand the high temperature can also cause other material changes that may be undesirable.

Due to the firing conditions during thermal activation in an oxidizing atmosphere, the iron compounds naturally present in the clays are converted into red iron oxides in particular. This results in a reddish coloration of the activated clays, which significantly reduces the market acceptance of cements produced in this way. The iron content, or rather the content of iron in its strongly coloring trivalent oxidation state (Fe³⁺), largely determines the color of a calcined clay. The color is an important quality parameter for the possible use of these activated clays as a component of the usually grey cement. Inferior (“lean”) clays in particular can have Fe₂O₃ contents of 2 to 9 wt % on average. In so-called “red clays”, the Fe₂O₃ content can also be up to 15 to 20%. During the calcination, these high iron contents can lead to a very intensive and usually undesirable red discoloration of the artificial pozzolan produced in this way and the composite cements produced with it, while clays that are low in iron result in a pink color. For this reason, firing conditions with reducing gas atmospheres, for example, are set in the calcination or post-calcination area of plants for the production of calcined clays in order in particular to achieve the conversion of Fe₂O₃ in minerals with red coloration such as hematite into black magnetite Fe₃O₄. The setting of reducing firing conditions in turn requires easily combustible primary fossil fuels such as natural gas, crude oil, lignite, or hard coal, which are also expensive and CO₂-intensive. The production of reducing firing conditions for color changing therefore actually runs counter to firing conditions for optimum fuel conversion. In particular, so-called secondary fuels require continuously oxidizing firing conditions for effective firing, which in turn requires a complex aftertreatment of the trivalent iron species in order to eliminate or reduce the undesirable red coloration in the thermally activated clay.

WO 2017/008 863 A1 discloses a method and plant arrangement for processing and activating a raw material.

EP 3 909 682 A1 discloses a method and roller mill for the thermomechanical activation of a clay mixture.

DE 10 2015 106 109 A1 discloses a method for the tribochemical activation of binders and additives.

A general overview of the prior art can be obtained, for example, from the following scientific publications:
Bolm, Carsten; Hernández, José G. (2018): Mechanochemistry of Gaseous Reactants (Appl. Chem. Int. Ed., 58). Available online at http://dx.doi.org/10.1002/anie.201810902.
Fernández, Rodrigo; Martirena, Fernando; Scrivener, Karen L. (2011): The origin of the pozzolanic activity of calcined clay minerals: A comparison between kaolinite, illite and montmorillonite. In: Cement and Concrete Research 2011 (41), pp. 113-122. DOI: 10.1016/j.cemconres.2010.09.013.
Ilić, Biljana; Radonjanin, Vlastimir; Malešev, Mirjana; Zdujić, Miodrag; Mitrović, Aleksandra (2016): Effects of mechanical and thermal activation on pozzolanic activity of kaolin containing mica. In: Applied Clay Science 2016 (123), pp. 173-181. DOI: 10.1016/j.clay.2016.01.029.
Tole, Ilda; Habermehl-Cwirzen, Karin; Cwirzen, Andrzej (2019): Mechanochemical activation of natural clay minerals: an alternative to produce sustainable cementitious binders—review. In: Miner Petrol 2019 (113), pp. 449-462. DOI: 10.1007/s00710-019-00666-y.
Tole, Ilda; Habermehl-Cwirzen, Karin; Rajczakowska, Magdalena; Cwirzen, Andrzej (2018): Activation of a Raw Clay by Mechanochemical Process-Effects of Various Parameters on the Process Efficiency and Cementitious Properties. In: Materials (Basel, Switzerland) 2018 (11). DOI: 10.3390/ma11101860
DE 10 2017 114 831 A1 discloses a method for processing fly ash and a method for producing cement.
CN 109 954 485 A discloses a method for producing activated clays.
CZ 307 528 B6 discloses a method for treating kaolin, clay, or a mixture thereof.
JP H08 67803 A discloses an epoxy resin and the production thereof.
CN 111 362 602 A discloses a method for changing the color of cementing material that contains clay.
WO 97/01614 A1 discloses clay activation with metal salts.
RU 2 209 824 C2 discloses a method for producing slurry powders.

Since clays constitute a complex system (especially in comparison to the burning of limestone), different activation methods yield different products (activated clays) with different properties. Likewise, the diversity of usable clays means that not every method can be used for every clay.

The object of the invention is to enable a color optimization in a simple way and thus in particular, to enable the use of otherwise unusable clays with a high iron content.

This object is attained by the method with the features disclosed in claim 1. Advantageous further embodiments ensue from the dependent claims, the following description, and the drawings.

The method according to the invention is used for the mechanochemical activation and simultaneous color optimization of mineral material. The aim, therefore, is on the one hand, to activate the mineral material mechanochemically in a first high-energy mill and not in a thermal process. On the other hand, the aim is to achieve color optimization at the same time as the activation and not to carry this out in a subsequent step, as is usually the case with thermal activation. Simultaneous activation and color optimization in a single grinding procedure and therefore in a single machine unit is therefore essential. The mechanochemical activation and simultaneous color optimization take place in a first high-energy mill.

For this purpose, the mineral material is ground together with a solid reducing agent in the first high-energy mill.

The mechanochemical activation consists of three phases or stages: In the first stage, the particle size decreases (more or less linearly) in relation to the energy input. Put simply, the more you grind, the finer the product becomes (Rittinger zone). However, there is a limit to this, a particle size below which it is almost impossible to go. After this point, one arrives at a second stage in which the particle size does not change any further with additional energy input (aggregation zone). In this stage, crystallographic structures are destroyed by the loosening of atomic bonds; individual atoms or entire groups of atoms are replaced by other atoms or groups of other atoms. Particularly on the particle surfaces, the initial crystal structure, the bond type, and the oxidation states of atoms are changed due to high energy transfer and subsequent chemical reactions. For economic reasons, the transition from the first stage to the second stage is therefore avoided during normal grinding in which only the production of a surface is to be achieved. This step is, however, necessary for the mechanochemical activation. If the energy input is increased even further, one can arrive at a third stage in which an increase in the particle size even due to the agglomeration of nanoparticles can be observed (agglomeration zone), which has a positive effect on the workability of activated clay-based cements in mortars and concretes. One is therefore much more likely to avoid this zone during a normal grinding since a better result in terms of particle size distribution can be achieved with less expense.

It has turned out, however, that high energy inputs, i.e. in the second stage, lead to changes in the material itself, which in the case of clays, for example, just like a thermal activation, lead to an activation, i.e. to a reactivity that enables the use of the material as a binder component (and thus as a clinker substitute). Therefore, with such high energy inputs, it is possible to dispense with subsequent thermal treatment.

In this case, however, it has turned out that the energy requirements for a purely mechanochemical activation can be higher than those for a thermal activation. Therefore, the method according to the invention initially appears to be disadvantageous compared to the conventional thermal activation. Despite the presumably comparatively high energy requirements, however, the method according to the invention turns out to be advantageous, particularly for the activation of clays. Especially in the case of complex starting materials such as clays, a thermal activation regularly yields multiple negative effects. On the one hand, it is known that, for example, substances in gaseous form can escape from clays at elevated temperatures, requiring more expensive waste gas purification, particularly with an additional CO₂ sequestration (carbon capture) that may be required in future. This can be avoided by not using higher temperatures. On the other hand, coloring components such as iron compounds are often oxidized at elevated activation temperatures, which in the case of iron leads to an undesirable red coloration of the product. On the contrary, simultaneous grinding with a solid reducing agent makes it possible to even use materials that are already strongly colored, in particular materials containing Fe₂O₃, for example clays known as “red clays”, as a starting material and to process these into a color-neutral product. Although this does increase the energy requirements for the actual activation step in the method according to the invention, it simplifies waste gas treatment and makes it possible to avoid a separate step with a subsequent reduction. The entire activation procedure for producing a marketable binder can thus be simplified in an efficient way. In addition, different clay minerals have different optimum activation temperatures. For example, minerals of the kaolin and chlorite group are activated at significantly lower temperatures than e.g. minerals of the mica group (muscovite, illite, and others). If the optimum activation temperature of kaolinite is selected for the thermal activation of clays containing minerals from these groups, then minerals such as muscovite and illite are not yet activated. If, however, the significantly higher activation temperature of muscovite and illite is selected for the thermal activation, then the formation of new mineral phases, especially spinels, leads to the overburning of the kaolinite, which results in deactivation. This differentiation of the clay minerals with regard to the optimum activation temperature, however, is eliminated with mechanochemical activation.

Coloring components such as iron compounds are often oxidized at higher activation temperatures, which in the case of iron leads to an increase in the undesirable red coloration in the product. By contrast with the thermal activation of clay, in which the clay minerals are dehydroxylated and the resulting water escapes completely, with the mechanochemical method according to the invention, it can be demonstrated that the water and hydroxyl groups of the clay minerals are retained in the mineral structure and are made available for a reaction, for example with a solid metal such as aluminum powder or zinc powder. The hydrogen produced during this reaction enables the conversion of Fe₂O₃ into Fe₃O₄ in the clay minerals, particularly in accordance with the following chemical reactions:

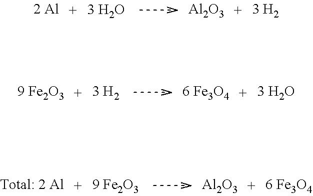

As can be seen from the reaction equations, this is a reaction that occurs auto-catalytically. This means that the water required for the first reaction step is not entirely consumed.
According to the invention, the color optimization method is particularly efficient because the kinetics of the chemical reduction reaction from Fe₂O₃ to Fe₃O₄ are improved by the availability in the clay minerals of the water molecules or hydroxyl groups that are required for the reduction reaction. This effect is based on the high energy level during the mechanochemical activation and the resulting surface chemistry. After the thermal activation, however, the water or hydroxyl groups that are required for such conversions are not present, the powerful mixing effect of the material during the mechanochemical activation due to the high speed of the agitator in the first high-energy mill.

According to the invention, the mechanochemical activation of the mineral material causes an increase in the R3 value (7d) determined for the assessment of reactivity or pozzolanicity according to ASTM C1897-20 by at least 150 J/g, preferably by at least 250 J/g compared to the starting material. The activation is thus high enough to allow the activated materials to be used as supplementary cementitious materials (SCM). The ASTM C1897-20 standard is a standard commonly used in the cement industry for testing the reactivity of cement additives and for characterizing the setting behavior.

In a further embodiment of the invention, the grinding and mechanochemical activation is carried out with an energy input per grinding chamber volume of at least 100 kW/m³, preferably at least 200 kW/m³. A typical value for a ball mill as an example of an ultrafine mill is usually closer to 20 kW/m³ and therefore significantly lower (and more energy-efficient). In this connection, the grinding chamber volume is understood to be the grinding chamber volume available inside the first high-energy mill, i.e. the free volume when there is no material and, for example, no balls in the first high-energy mill. Components belonging to the mill, for example a shaft that is movably arranged inside, are therefore not part of the grinding chamber volume since this volume cannot be occupied by material.

In a further embodiment of the invention, a size-selective separation into a coarse fraction and a fine fraction is carried out after the grinding. The fine fraction is transferred back to the first high-energy mill and the coarse fraction is removed as a product. For example, the separation is carried out using a separator. In this case, the fine fraction is returned since the activation is associated with an increase in particle size. This differs fundamentally from the normal separation and recirculation in a mill, in which the coarse fraction is normally recirculated.

In a further embodiment of the invention, the second size-selective separation is performed such that the size boundary between the second coarse fraction and the second fine fraction corresponds to the smallest particle size achievable with the second high-energy mill multiplied by a factor of 2.

In a further embodiment of the invention, the first high-energy mill is operated continuously. This means both that mineral material is continuously fed into the first high-energy mill and that at the same time, activated mineral material is continuously removed. Preferably, the first high-energy mill is therefore operated as a continuous mill with an input side and an output side.

In a further embodiment of the invention, the first high-energy mill is selected from the group comprising vibrating mills, planetary ball mills, and agitator bead mills. Preferably, the first high-energy mill is selected from the group comprising planetary ball mills and agitator bead mills. These types of mills have proven to be particularly suitable for the mechanochemical activation since these types of mills are able to achieve particularly high energy densities. It is particularly preferable to use a dry-operated agitator bead mill as the first high-energy mill.

In a further embodiment of the invention, an agitator bead mill with a length-to-diameter ratio of 2.5 to 5 is selected.

In a further embodiment of the invention, the first high-energy mill is filled with a grinding media fill level of from 50% by volume to 95% by volume, preferably from 60% by volume to 70% by volume. Here, the bulk volume of the grinding media relates to the volume of the first high-energy mill. Since the fill level is around 64% with a simple packing and only around 74% with the densest ball packing, even a theoretical grinding media fill level of 100% yields a corresponding free space, which can be occupied by the mineral material to be activated, for example. But since the fill level of a packing of grinding media is extremely dependent on the shape and uniformity of the grinding media, it is simpler from a practical standpoint for the grinding media fill level to relate to the bulk volume and not to the actual (filled) volume.

In a further embodiment of the invention, grinding media made of iron or an iron alloy or grinding media made of aluminum or an aluminum alloy are selected. Preferably, grinding media made of iron or an iron alloy are selected. In particular, grinding media made of steel are selected.

In a further embodiment of the invention, ceramic grinding media are selected.

In a further embodiment of the invention, grinding media with a diameter of from 1 mm to 10 mm are selected.

In a further embodiment of the invention, the agitator bead mill is operated at a peripheral speed of from 2 m/s to 6 m/s, preferably from 3 m/s to 5 m/s, particularly preferably from 3.5 m/s to 4.5 m/s.

In a further embodiment of the invention, the agitator bead mill is operated with a gas volume flow and a material flow. The ratio of gas volume flow to material flow is set such that the ratio of gas volume flow to material flow is between 0.0001 m³/kg and 5 m³/kg, preferably between 0.1 m³/kg and 2 m³/kg.

In a further embodiment of the invention, before being introduced into the first high-energy mill, the mineral material is dried and comminuted to a residual moisture content of less than 1% by weight and a particle size of less than 2 mm.

In a further embodiment of the invention, the mineral material is selected from the group comprising clay, ash, in particular fly ash, lime cement clinker, used concrete fines, slag, sheet silicates, and framework silicates. A particularly preferred mineral material is clay or a mixture of clay and one or more additional materials selected from the group comprising ash, in particular fly ash, fine cement clinker, used concrete fines, slag, sheet silicates, framework silicates, and limestone.

In a further embodiment of the invention, the mineral material is mechanochemically activated together with 0.1-50% by weight of quartz or corundum.

In a further embodiment of the invention, after the activation and color optimization, the material is analyzed to determine the activation. For the analysis, one or more methods are selected from the group comprising IR spectroscopy, RAMAN spectroscopy, X-ray diffraction analysis, heat flow calorimetry, thermogravimetry, scanning electron microscopy, particle size and/or particle shape analysis, NMR spectroscopy, and color measurement. One or more methods selected from the group comprising IR spectroscopy, RAMAN spectroscopy, X-ray diffraction analysis, heat flow calorimetry, and color measurement are particularly preferred for the analysis.

In a further embodiment of the invention, the gas selected and used for the gas flow through the first high-energy mill is a gas that comprises one or more gases selected from the group comprising nitrogen, argon, carbon dioxide, water vapor, carbon monoxide, hydrogen, and hydrocarbons, in particular methane, ethane, propane, and butane. Particularly preferably, the gas comprises mainly (more than 50% by volume) nitrogen, carbon dioxide, or water vapor. Particularly preferably, the gas comprises less than 1% by volume, preferably less than 0.1% by volume, of oxygen.

In a further embodiment of the invention, a metal with an electronegativity of less than 1.8, preferably less than 1.7, is selected as the reducing agent. This ensures reliable reduction of the trivalent iron.

In a further embodiment of the invention, a metal with a lower (more negative) normal potential than that of iron is selected as the reducing agent.

In a further embodiment of the invention, a metal from the group comprising aluminum, zinc, magnesium, and calcium is selected as the reducing agent. These metals have proven to be suitable for various reasons. Firstly, these elements are not harmful in the finished cement product, but are usually present anyway. Secondly, these metals, such as aluminum, are easily and inexpensively available. Furthermore, these metals are particularly suitable for the method according to the invention.

In a further embodiment of the invention, 0.01 to 1 mol of reducing agent is added per kg of mineral material added.

In a further embodiment of the invention, the amount of reducing agent is selected such that the electrons released by the oxidation of the metal correspond to 0.03 to 0.33 times the amount of Fe³⁺ contained in the mineral material. Theoretically, it would be sufficient to convert one third of all of the iron atoms into bivalent iron to form magnetite. However, it has been shown that as little as 10% results in a decolorization that leads to an acceptable product. This means that in this range, a product optimization (from acceptable to optimal) can be achieved at a cost (the less, the cheaper) that depends on the target market.

In a further embodiment of the invention, the reducing agent is added with a particle size of less than 100 μm. Preferably, the reducing agent is added with a particle size of more than 0.1 μm.

In a further embodiment of the invention, the reducing agent is added through abrasion of grinding media. Grinding media made of aluminum are preferably used for this purpose. This is preferred if the amount of reducing agent required is small, i.e. in particular for low-iron clays.

In a further embodiment of the invention, the reducing agent is selected from the group comprising tin (II) sulfate (ZnSO₄), antimony trioxide (Sb₂O₃), iron(II) sulfate (FeSO₄), iron(II) sulfate monohydrate (FeSO₄·H₂O), and iron(II) sulfate heptahydrate (FeSO₄·7H₂O). Particularly preferably, the reducing agent is selected from the group comprising tin (II) sulfate and antimony trioxide (Sb₂O₃).

In a further embodiment of the invention, elemental carbon from the group comprising coal, graphite, anthracite, carbon black, or petroleum coke in the presence of carbon dioxide is selected as the reducing agent.

In a further embodiment of the invention, elemental carbon from the group comprising coal, graphite, anthracite, carbon black, or petroleum coke in the presence of carbonates from the group comprising dolomite, magnesite, calcite, aragonite, iron carbonate, or alkali carbonates is selected as the reducing agent.

In a further embodiment of the invention, the method comprises a control circuit in which the amount of reducing agent added is controlled. The amount of reducing agent added is thus actively controlled. The Lab color value (also known as CIELAB or L*a*b*) of the activated material produced with the method is determined. In the Lab color value, the lightness value L* is perpendicular to the color plane (a*,b*) and is standardized in EN ISO 11664-4 “Colorimetry—Part 4: CIE 1976 L*a*b* color space”. The amount of reducing agent added is increased if the a* value exceeds 3 and is reduced if the a* value falls below 1. This optimizes the product for market acceptance and minimizes the consumption of reducing agent. Active control also enables an optimum adaptation to the usually fluctuating composition of natural clays, for example.

In a further embodiment of the invention, the method comprises a control circuit in which the amount of reducing agent added is controlled. The amount of reducing agent added is thus actively controlled. The Lab color value (also known as CIELAB or L*a*b*) of the activated material produced with the method is determined. In the Lab color value, the lightness value L* is perpendicular to the color plane (a*,b*) and is standardized in EN ISO 11664-4 “Colorimetry—Part 4: CIE 1976 L*a*b* color space”. The amount of reducing agent added is increased if the color index determined as the square root of the sum of (a*)² and (b*)2 is greater than 5, preferably greater than 10. Accordingly, the amount of reducing agent added is reduced if the color index determined as the square root of the sum of (a*)² and (b*)2 is less than 10, preferably less than 5.

In a further embodiment of the invention, a partial thermal activation is carried out prior to the mechanochemical activation. Preferably, the thermal activation is carried out at a temperature of less than 600° C., particularly preferably less than 500° C. Temperatures of 900° C., for example, are common for a purely thermal activation. On the one hand, this saves energy and thus at least partially reduces the energy requirements for the mechanochemical activation. On the other hand, though, the reduction of the maximum temperature also has further positive effects, for example the thermal formation of nitrogen oxides is reduced or unwanted product changes such as color changes due to oxidation of coloring components are avoided.

In a further aspect, the invention relates to a binder that is produced according to the method of the invention.

The method according to the invention will be explained in greater detail below with reference to an exemplary embodiment shown in the drawings.

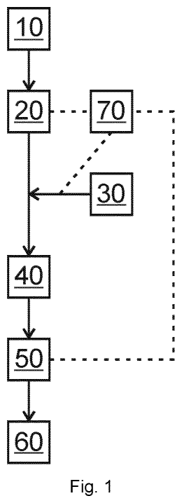

FIG. 1 flow chart.

A very schematic illustration of the method is shown in FIG. 1. Clay is taken from a clay store 10 as mineral material for activation and color optimization. It is conveyed past a sensor for chemical analysis 20 in order to determine the Fe³⁺ content. The determined Fe³⁺ content is transmitted to a control unit 70. The control unit 70 regulates the dosing of aluminum from an aluminum store 30 into the clay. The clay-aluminum mixture is transferred to a first high-energy mill 40, where it is ground and both activated and color-optimized within the method, i.e. simultaneously. The material coming out of the first high-energy mill 40 is examined in a color analysis 50, the L*a*b* color value is determined and transmitted to the control unit 70. The finished product is transferred to a product store 60.

Alternatively, a further color analysis corresponding to the color analysis 50 can be used instead of the chemical analysis 20. It is thus possible to simplify the procedure significantly. The color value of the clay is used and an Fe³⁺ content is assigned to the color value based on experience. The method can thus be carried out otherwise unchanged.

### REFERENCE NUMERALS

10 clay store
20 chemical analysis
30 aluminum store
40 first high-energy mill
50 color analysis
60 product store
70 control unit

1. A method for the mechanochemical activation and simultaneous color optimization of mineral material, characterized in that the mechanochemical activation and simultaneous color optimization take place in a first high-energy mill (40), wherein the mineral material is ground together with a solid reducing agent in the first high-energy mill (40) and wherein the mechanochemical activation of the mineral material causes an increase in the R3 value (7d) according to ASTM C1897-20 by at least 150 J/g, preferably by at least 250 J/g.

2. The method according to claim 1, characterized in that a metal with an electronegativity of less than 1.8 is selected as the reducing agent.

3. The method according to claim 1, characterized in that a metal with a lower (more negative) normal potential than that of iron is selected as the reducing agent.

4. The method according to claim 1, characterized in that a metal selected from the group consisting of aluminum, zinc, magnesium, and calcium is selected as the reducing agent.

5. The method according to claim 1, characterized in that 0.01 to 1 mol of reducing agent is added per kg of mineral material added.

6. The method according to claim 1, characterized in that the amount of reducing agent is selected such that the electrons released by the oxidation of the metal correspond to 0.03 to 0.33 times the amount of Fe³⁺ contained in the mineral material.

7. The method according to claim 1, characterized in that the reducing agent is added with a particle size of less than 100 μm.

8. The method according to claim 1, characterized in that the reducing agent is added through abrasion of grinding media.

9. The method according to claim 1, characterized in that the reducing agent is selected from the group consisting of tin (II) sulfate (ZnSO₄), antimony trioxide (Sb₂O₃), iron(II) sulfate (FeSO₄), iron(II) sulfate monohydrate (FeSO₄·H₂O), and iron(II) sulfate heptahydrate (FeSO₄·7H₂O).

10. The method according to claim 1, characterized in that elemental carbon selected from the group consisting of coal, graphite, anthracite, carbon black, or petroleum coke in the presence of carbon dioxide is selected as the reducing agent.

11. The method according to claim 1, characterized in that elemental carbon selected from the group consisting of coal, graphite, anthracite, carbon black, or petroleum coke in the presence of carbonates selected from the group consisting of dolomite, magnesite, calcite, aragonite, iron carbonate, or alkali carbonates is selected as the reducing agent.

12. The method according to claim 1, characterized in that the method comprises a control circuit, wherein the amount of reducing agent added is controlled, wherein, for example, the L*a*b* color value is determined from the activated material that is produced with the method, wherein the amount of reducing agent added is increased if the a* value exceeds 2 and wherein the amount of reducing agent added is reduced if the a* value falls below 1.

13. The method of claim 1, characterized in that a partial thermal activation is carried out before the mechanochemical activation.

14. (canceled)
